(19) United States
(12) Patent Application Publication
(10) Pub. No.: US 2008/0144604 A1
(43) Pub. Date: Jun. 19, 2008

(54) INTERFACE-NEUTRAL COMMUNICATION ARCHITECTURE

(75) Inventors: Bhanu Sharma, San Bruno, CA (US); Sanjay Chouksey, Santa Clara, CA (US)

Correspondence Address: FULBRIGHT & JAWORSKI, LLP (ADOBE), 2200 ROSS AVENUE, SUITE 2800, DALLAS, TX, 75201-2784, US

(73) Assignee: Adobe Systems Incorporated, San Jose, CA (US)

(21) Appl. No.: 11/611,046

(22) Filed: Dec. 14, 2006

(51) Int. Cl. H04L 12/66; G06F 3/00

(52) U.S. Cl. 370/352; 719/328

(57) ABSTRACT

A method for delivering two-way real-time communication functionality, comprises providing a user interface neutral communication software library including telephony communication protocol functionality, implementing the communication software library in an interactive application, and implementing a user interface for the interactive application that allows an end user to control a calling engine that is adapted to employ the communication software library in order to send and receive voice data over one or more networks.

### CROSS-REFERENCE TO RELATED APPLICATIONS

This application is related to commonly-assigned and concurrently filed United States Application serial no. [Attorney docket number 346], entitled “REAL-TIME COMMUNICATION USING INTER-PROCESS COMMUNICATIONS,” the disclosure of which is hereby incorporated herein by reference.

### TECHNICAL FIELD

This description relates, in general, to real-time voice communication and, specifically, to the architectures and implementation of real-time voice communication techniques.

### BACKGROUND OF THE INVENTION

Recently Voice Over Internet Protocol (VoIP) phone service has become popular with consumers, with more people and businesses choosing to migrate to it and away from traditional Plain Old Telephone Service (POTS) every year. VoIP service is a telephone service that uses the Internet to make telephone calls, usually for a fixed fee and a very low per-minute charge, even for some international calls, VoIP systems can be either hardware-based, with special telephone sets or adapters for regular phones in communication with a network router or software-based, thereby allowing a user to employ a personal computer as a telephone.

Software-based VoIP phones are sometimes referred to as “softphones,” and they vary from service to service. Attention has recently been focused on providing softphone functionality in web browsers. In one example, a browser plug, in provides softphone service to a user through the browser. Typical of current softphones, the user interface and the functionality of the phone are closely linked. In other words, current softphones are not adaptable to new or different user interfaces. This can make softphone functionality difficult for developers of web pages and Rich Internet Applications (RIAs) to leverage, since a developer who desires to implement phone technology in an application will generally have to rely on the functionality provided by a web browser plug-in or to develop a separate softphone from scratch. Further, since there are different browser plug-ins available, not every application will work with every browser. There is no solution currently on the market that gives developers control over real-time communication functionality and can be nearly universally useable.

### BRIEF SUMMARY OF THE INVENTION

Various embodiments of the present invention include systems, methods, and computer program products for implementing real-time voice communication technology in end user applications (e.g., web pages, banner advertisements, Rich Internet Application (RIAs), and the like) using an interface-neutral calling engine. Various embodiments can provide real-time voice/video/data communication using VoIP techniques, video conference techniques, peer-to-peer techniques, and the like.

In one example, a communication software library of computer-executable code, when executed, provides an end user with a software-based calling engine. A developer can use the library to implement the real-time communication features, and since the library is interface-neutral, the developer may use any type of interface he or she desires, whether it is created new or reused from a previous implementation. The calling engine is a part of the application so that when an end user downloads or opens the application, the interface is presented to the end user. By interacting with the interface, the end user can exercise some control over the calling engine to establish and/or disconnect a session with a remote communicator.

In one embodiment, the communication software library includes script-based Application Programming Interfaces (APIs) that are exposed to the developer. The APIs provide the functionality for the calling engine. Thus, in one example, the library is a scripting language based implementation of a real-time voice communication program. For example, one embodiment includes telecom-level VoIP service provided in JAVASCRIPT™, from Netscape, ACTIONSCRIPT™, from Adobe Systems Incorporated, or the like. It is possible to have APIs that handle very low-level complexities of the communication technology and also to have high-level APIs that provide developers with methods that are easy to use and understand without an intimate knowledge of for example, VoIP or other kinds of real-time communication technology. In this type of embodiment, complex communication functionality becomes accessible to the typical World Wide Web or Internet application developer.

An advantage of some embodiments is that developers can create applications that include their own real-time communication functionality, and the developers have flexibility to apply user interfaces of their own choice. Another advantage is that embodiments that use ACTIONSCRIPT™ to write the communication software library can leverage the near universal deployment of the FLASH® player, available from Adobe Systems Incorporated.

### BRIEF DESCRIPTION OF THE DRAWINGS

FIG. 1 is an illustration of an exemplary system adapted according to one embodiment of the invention;

FIG. 2 is a conceptual diagram of an exemplary system adapted according to one embodiment of the invention, and it shows how a real-time voice communication engine, such the system of FIG. 1 may be implemented and used in one particular scenario;

FIG. 3 is an illustration of an exemplary method adapted according to one embodiment of the invention; and

FIG. 4 illustrates an exemplary computer system adapted according to one embodiment of the present invention

### DETAILED DESCRIPTION OF THE INVENTION

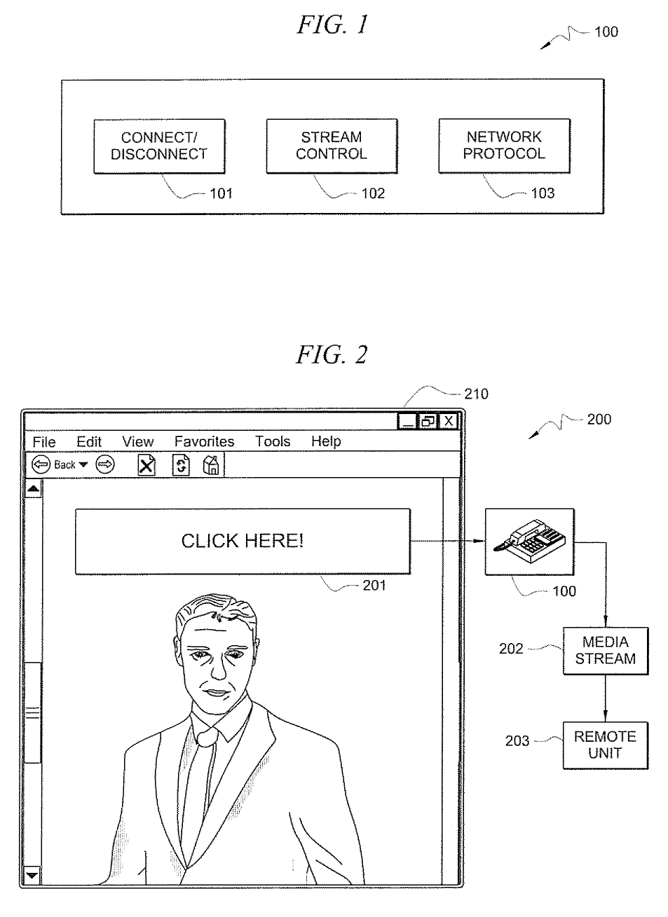

FIG. 1 is an illustration of exemplary system 100 adapted according to one embodiment of the invention. System 100, in this example, is a computer program product including computer-executable code saved to a computer-readable medium. The code can be executed by the computer to provide real-time voice communication functionality, as described below.

System 100, when executed by a processor-based system, provides telephone or other voice/video/data communication functionality to an end user, and it includes connect/disconnect module 101, stream control module 102, and network protocol module 103. Further, system 100 is user interface neutral, that is, modules 101-103 are not necessarily adapted for any one user interface and can, in some embodiments, be used with any of a variety of user interlaces.

System 100 may include many, if not all, of the logical building blocks that make up a software telephone (a “softphone”) in some embodiments. For example, in a telephony embodiment, connect/disconnect module 101 sends control signals to establish and disconnect telephone calls, handle routing decisions, and provide services, such as, for example, call waiting, call forwarding, and the like, by using telephony signaling protocols. Traditional and wireless telephone systems typically use the SS7 signaling protocol. In Voice Over Internet Protocol (VoIP) systems, the usual signaling protocol is Session Initiation Protocol (SIP), which is a text-based protocol based on Hypertext Transfer Protocol (HTTP) and Multipurpose Internet Mail Extension (MIME). Yet another type of signaling protocol is H.323 which is a standard for real-time voice and videoconferencing over packet networks. For VoIP-type applications, SIP may be the preferred signaling protocol because of its robustness and its relative simplicity compared to H.323. However, in system 100, any technique for establishing and disconnecting a communication session now known or later developed may be used.

Stream control module 102 controls media streaming that delivers and receives audio and/or video data. For example, in a VoIP application, module 102 uses information from connect/disconnect module 101 to instruct a streaming engine (not shown) to send and receive audio data to/from a network address associated with a remote communicator. Thus, in such an example, stream control module 102 controls the streaming engine to receive audio data coming from a microphone and to stream that data to a particular network address and also controls the streaming engine to listen to a specific IP address and to deliver the received audio information to speakers. In some embodiments, stream control module 102 and the streaming engine may be implemented in the same module or set of code. However, in embodiments wherein system 100 is implemented in a Hypertext Markup Language (HTML) application, stream control module 102 may be separate from a streaming engine because HTML does not generally support real-time communication.

Network protocol module 103 provides transport functionality for both audio data and signaling-type data by handling the protocols that are required by one or more of the networks being used. For example, in a VoIP application, the audio information is sent through the Internet using User Datagram Protocol (UDP) over Transmission Control Protocol/Internet Protocol (TCP/IP). In such an example, network protocol module 103 forms packets by adding the appropriate headers, negotiates to send data, controls transmitting and receiving over various ports, and the like. Embodiments of the invention are not necessarily limited to using only UDP over TCP/IP, as various embodiments can be adapted to work with any network and its particular protocols. For example, one additional protocol that can be used is Transport Layer Security (TLS), which uses digital certificates to authenticate a user. In short, network control module 100 facilitates network communication.

In some embodiments, modules 101-103 of system 100 form one or more libraries of Application Programming Interfaces (APIs) that are provided to application developers. Application developers may then use the libraries to create interactive and multi-media applications (e.g., Web pages, Rich Internet Applications (RIAs), and the like) that support real-time voice and/or video communication. Thus, developers may implement the libraries in the application by writing function calls in one or more source files for the application. In such examples, the APIs can be created using a scripting language. Various scripting languages can be used, including, for example, JAVASCRIPT™ and ACTIONSCRIPT™. Accordingly, in some embodiments, very low-level (as well as very high-level) telephone signaling and media functionality can be implemented in scripting code and provided as a library of APIs.

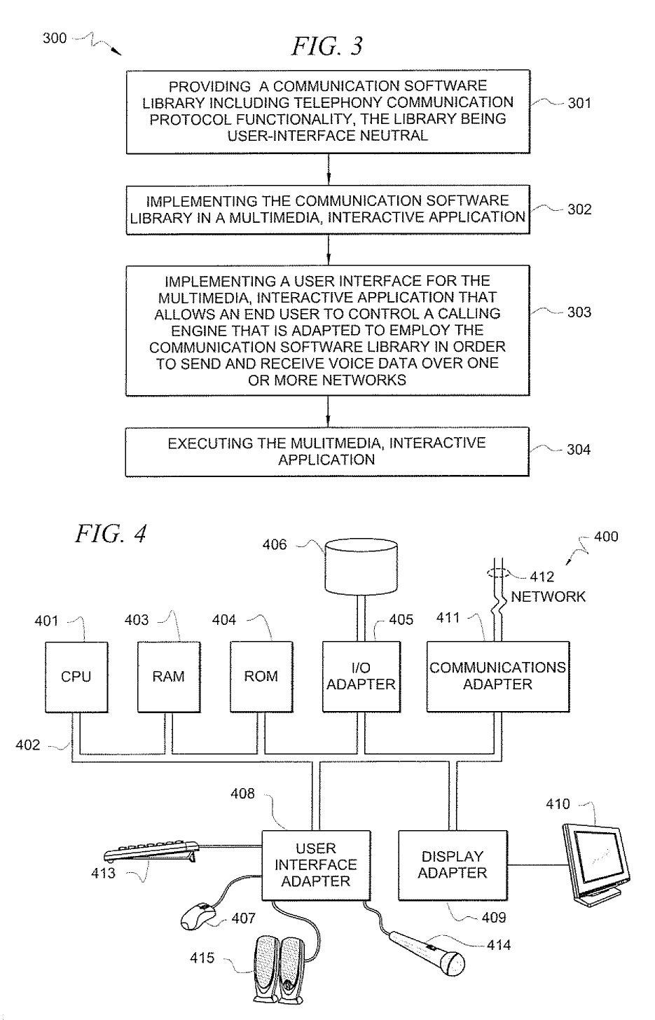

As mentioned above, system 100 is user interface neutral and, therefore, provides various communication functionality but is not limited to any given user interface. The interface neutrality, or “headlessness” may allow the application developer to design a custom user interface or use a previously-created interface in the application for controlling the real-time communication functionality. Such an embodiment is described further below with regard to FIG. 3.

FIG. 2 is a conceptual diagram of exemplary system 200 adapted according to one embodiment of the invention, which shows how a real-time voice communication engine, such as system 100, may be implemented and used in one particular scenario. In this example, a developer has created banner advertisement 201 that beckons a user to “click here.” Banner advertisement 201 is part of an application that is executed by browser 210. Banner advertisements are often created using FLASH®, available from Adobe Systems Incorporated, wherein a developer creates the banner using vector and/or bitmap graphics and uses ACTIONSCRIPT™ to provide interactive functionality. The application is sent to an end user's computer as a compiled Small Web Format (SWF) file that is played by a FLASH® player which may be operated as a plug-ins or extension to a web browser (as in this example) or operated as a stand-alone player. In these embodiments, the real-time voice functionality comes from executing the banner rather than from any specific or built-in voice capability of the FLASH® player,

The user interface of banner advertisement 201 is the area available to the user for selecting. In this example, the user's selecting indication (e.g., clicking) is control information that causes system 100 to initiate a VoIP call to the advertiser at remote unit 203. Such functionality may be included in banner advertisement 201 by writing ACTIONSCRIPT™ code that looks for a user's selecting indication and provides a network address or telephone number to system 100 along with an instruction to set tip a VoIP connection thereto.

Developer ease of use may be facilitated in some embodiments by including high-level telephone functionality in system 100. For example, APIs in system 100 can be created that receive a telephone number or other network address and use other APIs to construct, conduct, and end the call on a lower level of abstraction. Thus, rather than having to be similar with details of VoIP technology, a developer can write high-level function calls that may be as simple as, for example, receiving a telephone number, starting a call ending a call, and the like. In this way, system 100 may actually “hide” the technical details of VoIP from a developer while providing easy-to-use APIs. On the other hand, such system may also expose lower-level APIs to the developer should the developer wish to be involved at such a level. In Fact, various embodiments of the invention can expose protocol-level APIs for the use of developers who desire very low-level network and telephony programming.

System 100 sets up a VoIP call to remote unit 203 using SIP or other signaling, as described above. System 100 then uses APIs to control media stream unit 202 to listen to an address associated with remote unit 203 and to deliver received audio data to user interface hardware (e.g., system speakers). System 100 also uses APIs to send user interface hardware data (e.g., microphone data) to the same or different address associated with remote unit 203. In various embodiments, media stream unit 202 may be separate from or included in system 100. In this example, media stream unit 202 is separate from system 100 and is implemented in an object oriented or procedural language such as C++, C, or the like. Thus, while system 100 operates inside browser 210 in this example, media stream unit 202 may be adapted to operate in browser 210 or as a separate functional unit. Communication between system 100 and media stream unit 202 can be accomplished through, for example, a TCP/IP socket.

FIG. 3 is an illustration of exemplary method 300 adapted according to one embodiment of the invention. Method 300 is a method for providing real-time voice communication functionality, and it may be performed, for example, by a developer creating an application that supports VoIP calls, video conferencing, and/or the like by an end user.

In step 301, a user interface neutral communication software library is provided, and it includes telephony communication protocol functionality. In one example, the library includes high- and low-level APIs that allow the developer to create an application that provides VoIP or other voice functionality to an end user through use of the application. Thus, in one specific example, the libraries may support a scripting language-based softphone with signaling functions, media streaming functions, network transport functions, and or the like. The library is user interface neutral so that the developer may have a choice of user interfaces in the final application.

In step 302, the communication software library is implemented in a multimedia, interactive application. This can be performed, for example, when a developer writes functions calls in the source code of the application that, in effect, create a calling engine when the application is opened or executed by a user's computer.

In step 303, a user interface is implemented for the multimedia, interactive application that allows an end user to control a calling engine adapted to employ the communication software library in order to send and receive voice data over one or more networks. Thus, when an end user's computer is executing the application, the end user is provided an interface for controlling at least some of the operation of the calling engine. In the example of FIG. 2, the user interface is contained in a banner-type advertisement that the user can select, thereby initiating a VoIP call. Various embodiments can be adapted to include other types of user interfaces. In one example, the user interface is a button pad that allows a user to connect and disconnect a VoIP call to a telephone number of the user's choosing. The “called party” is not limited to a telephone user in some embodiments, as voice communication can be established with any supporting device, including, for example, computers, Personal Digital Assistants, and the like. Further, it is possible in some embodiments for an end user to receive an incoming call from, for example, an advertiser. However, this may be disturbing to some end users and may be restricted, in one example, by licensing, conditions from an originating source (i.e., the source that provides the library to the developer) that limits the allowed uses employed by the developer.

In step 304, the interactive, multimedia application is executed, for example, on a browser. In one example, the developer performs steps 301-304 in a application development environment that includes a design view that renders the application as it is being developed. In such an example, the developer can test the application and run many of its features during development. In another example, step 304 is performed at an end-user's computer when the end-user downloads the application from a network, such as the Internet.

Various embodiments are not limited to VoIP technology or even to telephony, as any kind of real-time communication that includes at least voice may be used with various embodiments. Examples include voice/video conferencing and voice/video/data conferencing. Communications can be through a server or can be peer-to-peer. Developers may use embodiments of the invention to add voice features to any kind of end user application. For example, system 100 (FIG. 1) can be implemented in an instant messenger-type application to allow users to establish a voice/video connection in addition to the text communication that is traditionally provided. In another example, a social networking website that includes the profiles of people and organizations employs a feature whereby one user can call another by selecting an icon or entering a code in a pop-up window. Additionally, a system, such as system 100, can be integrated into a web portal or even into a web browser to allow a wide variety of Internet users to establish voice connections.

Various embodiments of the present invention may offer one or more advantages over prior art solutions. For example, current VoIP applications are centered around their interfaces and are generally inseparable therefrom. This is in contrast to embodiments of the present invention that provide user interface neutral voice communication engines, wherein the functionality of the voice communication engines are separate from their respective user interfaces. The interface neutrality can provide a developer with flexibility in designing a user interface and in designing applications in general that provide real-time voice communications. In other words, the developer may start with an out-of-the-box solution that can be easily implemented in a given application while giving the developer freedom in choosing/designing a user interface.

Another distinction is that while most real-time voice communication solutions are large software packages or are integrated into large software packages, various embodiments of the present invention can be deployed to the user directly when the user selects an application (e.g., a website) from a network. Such embodiments include most or all of the calling functionality in the application, so that if a content provider (e.g., an owner of a webpage) desires to change the calling functionality, he or she can change the webpage itself so that the user is usually not required to change software on his/her machine. This can be important in some embodiments, since it is generally easier to get an end user to open a webpage or click on a feature than it is get a user to download and install a software package. In embodiments wherein the application is a FLASH®-based application (e.g., the banner advertisement of FIG. 2), a developer or webpage owner can leverage the high rate of FLASH® player deployment, knowing that the majority of end users can experience the functionality of the application without changing hardware or software configurations.

When implemented via computer-executable instructions, various elements of embodiments of the present invention are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like). In fact, readable media can include any medium that can store or transfer information.

FIG. 4 illustrates exemplary computer system 400 adapted according to embodiments of the present invention. That is, computer system 400 comprises an example system on which embodiments of the present invention may be implemented (e.g., such as a computer used by a developer in creating an application or a computer used by an end user to access and execute an application). Central processing unit (CPU) 401 is coupled to system bus 402. CPU 401 may be any general purpose CPU. However, the present invention is not restricted by the architecture of CPU 401 as long as CPU 401 supports the inventive operations as described herein. CPU 401 may execute the various logical instructions according to embodiments of the present invention.

Computer system 400 also preferably includes random access memory (RAM) 403, which may be SRAM, DRAM, SDRM, or the like. Computer system 400 preferably includes read-only memory (ROM) 404 which may be PROM, EPROM, EEPROM or the like. RAM. 403 and ROM 404 hold user and system data and programs, including, for example, libraries that support real-time voice communication functionality and applications that include such libraries.

Computer system 400 also preferably includes input/output (I/O) adapter 405, communications adapter 411 user interface adapter 408, and display adapter 409. I/O adapter 405, user interface adapter 408, and/or communications adapter 411 may, in certain embodiments, enable a user to interact with computer system 400 in order to input information, such as voice and video data, as with microphone 414 and a camera (not shown). In addition, it may allow for the output of data, as with speakers 415.

I/O adapter 405 preferably connects to storage device(s) 406, such as one or more of hard drive, compact disc (CD) drive, floppy disk drive, tape drive, etc. to computer system 400. The storage devices may be utilized when RAM 403 is insufficient for the memory requirements associated with storing data for applications. Communications adapter 411 is preferably adapted to couple computer system 400 to network 412 (for example, the Internet, a Local Area Network (LAN), Wide Area Network (WAN), Public Switched Telephone Network (PSTN), cellular network, and the like). User interface adapter 408 couples user input devices, such as keyboard 413, pointing device 407, and microphone 414 and/or output devices, such as speaker(s) 415 to computer system 400. Display adapter 409 is driven by CPU 401 to control the display on display device 410 to, for example, display the user interface (such as that of FIG. 2) of embodiments of the present invention.

It shall be appreciated that the present invention is not limited to the architecture of system 400. For example, any suitable processor-based device may be utilized, including without limitation personal computers, laptop computers, handheld computing devices, computer workstations, and multi-processor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacturer compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for delivering real-time communication functionality, said method comprising:
providing a communication software library including telephony communication protocol functionality, said library being user interface neutral;
implementing said communication software library in a multimedia, interactive application; and
implementing a user interface for said multimedia, interactive application that allows an end user to control a calling engine executing said communication software library in order to send and receive voice data over one or more networks.

2. The method of claim 1 wherein said calling engine is operable to establish a two-way connection with a remote communicator and to communicate with a media engine that provides media streaming between a user and said remote communicator.

3. The method of claim 2 wherein said calling engine is operable to control said media engine to direct said media engine to send microphone data to a network address associated with said remote communicator and to receive audio data from said network address associated with said remote communicator.

4. The method of claim 1 wherein said communication software library is provided in a scripting language.

5. The method of claim 1 wherein said providing a communication software library comprises:
providing a library of exposed Session Initiation Protocol (SIP) Application Programming Interfaces (APIs) in a scripting language.

6. The method of claim 1 wherein said implementing said communication software library in said multimedia, interactive application comprises:
incorporating said library into one or more source files that make up said multimedia, interactive application.

7. The method of claim 1 wherein said implementing said user interface comprises:
writing function calls in one or more source files that make up said multimedia, interactive application, said function calls linking said user interface to said calling engine.

8. The method of claim 1 wherein said implementing a user interface comprises:
providing functionality that allows an end user to make a telephone call over a network by interacting with said multimedia, interactive application.

9. The method of claim 1 wherein said communication software library comprises:
a signaling library of Application Programming interfaces (APIs) operable to provide signaling functionality to said calling engine;
a media library of APIs operable to provide logic to said calling engine to control a media stream application to stream audio data to a remote destination and to receive audio data from said remote destination;
a transport library of APIs operable to provide functionality to said calling engine to communicate with said remote communicator over one or more networks through use of one or more network protocols; and
a telephony library of APIs operable to provide access to said signaling library, said media library, and said transport library through a higher level of abstraction during said implementing said telephone software library.

10. The method of claim 1 wherein said calling engine is operable to provide one or more of the following:
telephone functionality; and
audio/video conference functionality.

11. The method of claim 1 wherein said multimedia, interactive application is a banner application with an area for an end user to select.

12. A computer program product having a computer readable medium having computer program logic recorded thereon for providing communication over a networks said computer program product comprising;
code when executed by a computer for providing real-time voice communication over one or more networks, said code for providing real-time voice communication including:
code for establishing and disconnecting a telephone call;
code for controlling the sending and receiving of real-time media streams to and from a remote destination; and
code for communicating with said remote destination using one or more network communication protocols, wherein said code for establishing and disconnecting, a telephone call, code for controlling the sending and receiving, and said code for communicating with said remote destination are user interface neutral.

13. The computer program product of claim 12 wherein said code for establishing and disconnecting a communication session comprises:
code for providing telephone signaling functionality.

14. The computer program product of claim 11 wherein said code for providing telephone signaling functionality comprises:
Application Programming Interfaces (APIs) Written in a scripting language providing Session Initiation Protocol (SIP) functionality, said APIs being exposed for use by a developer of an Internet application.

15. The computer program product of claim 12 wherein said code for providing real-time voice communication over one or more networks is selected from a list consisting of:
a banner advertisement; and
an HTML and script based web page.

16. The computer program product of claim 12 further comprising:
code for providing a user interface, said user interface providing signals that indicate a network address for said remote destination and that control the establishing and disconnecting of said telephone call.

17. A method for developing a user application, said method comprising:
providing a telephone software library including signaling protocol functionality, network transport protocol functionality, and media stream controlling functionality, said library being implemented in scripting code;
providing a telephony engine that is operable to use said telephone software library to communicate over one or more networks; and
implementing said telephone software library in a multimedia application with a user interface that allows an end user to control said telephony engine.

18. The method of claim 17 wherein said telephone software functionality is user interface neutral.

19. The method of claim 17 wherein said communication software library comprises:
a signaling library of Application Programming Interfaces (APIs) operable to provide signaling functionality to said telephony engine,
a media library of APIs operable to provide logic to said telephony engine to control a media stream application to stream audio data to a remote destination and to receive audio data from said remote destination;
a transport library of APIs operable to provide functionality to said telephony engine to communicate with said remote communicator over one or more networks through use of one or more network protocols; and
a telephony library of APIs operable to provide access to said signaling library, said media library and said transport library through a higher level of abstraction during said implementing said telephone software library.

20. The method of claim 17 wherein said signaling library APIs provide Session Initiation Protocol (SIP) functionality.

21. A system for providing real-time voice communication over one or more networks, said system including;
a first functional unit adapted to establish and terminate peer-to-peer communications between said system and a remote end point;
a second functional unit adapted to control the sending and receiving of real-time media streams to and from the remote end point, and
a third functional unit adapted to communicate with said remote end point using one or more network communication protocols, wherein said first, second, and third functional units are user interface neutral.

22. The system of claim 21 wherein said system provides Voice Over Internet Protocol (VoIP) functionality from an Internet browser program.
